(19) United States
(12) Patent Application Publication
(10) Pub. No.: US 2004/0186597 A1
(43) Pub. Date: Sep. 23, 2004

(54) Method of optimizing adjustable parameters

(76) Inventors: Heinz-Hermann Wippersteg, Buende (DE); Werner Fitzner, Sassenberg (DE)

Correspondence Address: STRIKER, STRIKER & STENBY, 103 East Neck Road, Huntington, NY, 11743, US

(21) Appl. No.: 10/781,092

(22) Filed: Feb. 17, 2004

(30) Foreign Application Priority Data
Feb. 17, 2003 (DE) 103 06 726.4

(51) Int. Cl. G06F 9/45

(52) U.S. Cl. 700/31

(57) ABSTRACT

A method of optimization of adjustable parameters of at least one machine includes providing a data processing system, and optimizing adjustable parameters by processing of at least one process algorithm provided in the data processing system.

### BACKGROUND OF THE INVENTION

The present invention relates to a method of optimizing adjustable parameters.

A plurality of working machines are known in the prior art, whose operational parameters significantly depend on materials to be processed, on weather-dependent environmental influences and on efficiency characteristics of the work machine. For example there are agricultural and forestry working machines and also production machines which for example from natural products, so called growing row products, produce intermediate or finished products.

On the one hand the type of the further processing of natural products significantly depends on the property of the natural products. In addition to different growth-enhancing maintenance features, in particular the weather conditions significantly determine the quality of the grown natural products, so that the same products, due to their growth-dependent properties which significantly differ from one another, must have a completely different further processing, to obtain the same intermediate and finished products. In addition, the harvesting process of such products significantly depends on the quality of the material to be harvested and on the weather-dependent outer influences. As an example so-called combined harvesters or forage harvesters are known, whose different working elements are very sensitive changing properties of the material to be harvested. In order to maintain high the efficiency of these working machines and the quality of the materials to be harvested, despite considerable fluctuations of the properties of the crop and the weather-dependent changing harvesting conditions, extensive controls for optimization of the operational parameters of the working elements of these machines are carried out. Such optimization processes are performed nowadays by the operator of the corresponding machine and significantly depend on his experience and skill.

In order to increase the quality of this optimization process, the machine operator, in addition to its experience can rely on manufacturer recommendations and sensor-generated machine informations. In particular, the sensor-generated machine informations serve the machine operator for assessing the action of his adjusting steps. Furthermore, in connection with this the so-called loss sensors are widely utilized in agricultural harvesters, such as combined harvesters, for determination of the corn loss. The loss sensors supply signals which are proportional to the corresponding grain loss, from which the machine operator can obtain the information whether a performed change of one or several operational parameters of the combine harvester led to a reduction or increase in corn losses, which have to be kept as low as possible. In particular when several operational parameters are changed, it depends significantly on the experience of the machinists whether the introduced action is associated with the correct operational parameter. Such an action in practice leads to the situation that the machine operator at a certain time must test too many machine adjustments, before he reaches an optimal adjustment of the machine in accordance with his opinion, wherein the less experienced the machine operator the greater the number of such tests. In addition, the machine operator during this operational parameter optimization must process a lot of information without available supporting auxiliary means for this optimization process. In addition, the reproducibility of determined once operational parameter in dependence on different machine-, crop- and environment—in particular weather-specific parameters is not provided.

### SUMMARY OF THE INVENTION

Accordingly, it is an object of the present invention to provide a method of optimizing adjustable parameters, which is a further improvement of the existing methods.

More particularly, it is an object of the present invention to provide a simple method of optimizing adjustable parameters which relieves a machine operator, and which is cost favorable and efficient.

In keeping with these objects and with others which will become apparent herein after, one feature of the present invention resides, briefly stated, in a method of optimization of adjustable parameters of at least one machine, comprising the steps providing a data processing system; and optimizing adjustable parameters by processing of at least one process algorithm provided in the data processing system.

Since in accordance with the applicant's invention the optimization of the adjustable parameters is performed by processing of at least one action algorithm provided in a data processing system, the optimization of the adjustable parameter is significantly uncoupled from the experience of the machinist, so that the carried out optimization process leads to optimized machine adjustments. This significant uncoupling of the optimization process from the experience of the machinist has a special importance when the machines are operated by services whose machinists controlling the machines frequently are not experts in the corresponding area, and therefore they do not have extensive experience or do not have the experience at all.

When the optimization of the adjustable parameters in addition is determined by editable and/or storable target data, then in a simple manner it can be guaranteed that depending on better or worse outer conditions, also qualitatively higher-grade or lower-grade target data are retrievable in defined inner and repeatable way. This has the advantage that the system to be optimized utilizes the inventive optimization method only in realistic regions of the target data.

An especially simple structure of the data processing system is obtained when the data processing system is formed as a diagnosing system. This has a special disadvantage that in the simplest case for conversion of the data processing system it is possible to rely on a conventional software, which then must be adapted for realization of the inventive method only to the concrete conditions of the respective machine and/or respective process.

For increasing the efficiency and the accuracy of the optimization method, the data processing system can process both machine-internal and machine-external data with consideration of target data, and generate further processible output data.

An optimization method which is adaptable in a particular user-free and flexible manner to different condition, is provided when the machine-internal data and the machine-external data as well as the output data are editable and storable by the data processing system.

A further advantageous embodiment is provided when the data processing system operates in accordance with time control. This has on the one hand the advantage that in particular during the optimization of the operational parameters of agricultural machines to daytime-dependent fluctuations the crop properties can be better entered. In addition, the optimization process can be repeated in a time-dependent fashion, so that it can flexibly react to changing conditions.

The efficiency and the handling of the optimization method increases also further when the machine-internal data transmitted to the data processing system, in addition to the adjustable parameters to be optimized, also includes further parameters, such as substantially crop-specific and/or machine-specific parameters as well as internal expert knowledge, and their generation is performed by sensors which are in operative communication with the machine or by inputting.

An optimization which is particularly simple to handle is provided when the adjustable parameters to be optimized are formed by the traveling speed, the rotary speed of at least one threshing drum and/or the rotary speed of the blower of the at least one cleaning device, and the further parameters represent the grain loss, the grain throughput, the crop moisture, the crop total throughput and/or the broken corn fraction.

In order to increase the universal use of the inventive method, the further parameters can include also adjustment regions for the parameters of the working units.

The precise and fast optimization of the adjustable parameters is enhanced when the machine-external data are generated by external systems and include geographical data, weather data, plant-specific data or external expert knowledge.

The internal as well as the external expert knowledge becomes especially important when it is supported by expert knowledge of crop-related and machine-related experience knowledge.

In order to decrease the efficiency of the optimization process the at least one process algorithm which is provided in the diagnosis system can process so-called process diagnoses and/or case diagnoses and/or model oriented diagnoses. This has the advantage that the diagnosis system can adapt the optimization method in application-specific manner. In particular, the case-oriented diagnosis has the advantage that here self-learning effect can be obtained, which allows to the diagnosis system to rely in future optimizations with similar case designs on already existing process algorithms and thereby determined optimized parameters. With such an adaptation of the process algorithms it is possible to successively improve the quality and efficiency of the inventive optimization method.

For providing a flexible use of the inventive method for optimization of adjustable parameters, in accordance with a further advantageous embodiment of the present invention it is proposed that the process algorithm of the data processing system be processed is selectable in dependence on at least one part of the machine-interior and/or machine-exterior data from a plurality of process algorithms.

The machinist is further relieved from the optimization process of the adjustable parameters of the machine, when the data processing system proposes or automatically selects the process algorithm depending on the machine-interior and/or machine-exterior data.

For simplification and acceleration of selection of the suitable process algorithm stored in the data processing system, in accordance with an advantages further embodiment of the inventive method the machine-internal and the machine-external data as well as the target data can be stored in data sets in the data processing system, which simultaneously defines a situation pattern, to which a completely concrete process algorithm is coupled. The selection of a new process algorithm can be performed then with the use of the situation pattern. From the stored situation patterns, a situation pattern which is close or identical to the instantaneous situation pattern finally the process algorithm linked to this situation pattern is selectable for processing in a simple manner.

A further increase of the flexibility of the inventive method is obtained when the data processing system can generate changed method algorithms and/or situation patterns, depending on the machine-interior and machine-exterior data and with consideration of changeable target data. In this way, it is possible that the stored process algorithms and situation patterns are adaptable very precisely to individual application cases, for future similarly designed application cases can be retrieved directly in time-saving manner without adapting the already provided process algorithms and/or situation patterns to the new application conditions.

In order to efficiently use the inventive optimization method embracing the machines, in accordance with a further embodiment of the invention is proposed that the situations pattern and associated process algorithms and/or the optimized adjustable parameters are provided further machines in the data processing system.

An especially advantageous application case is provided when the machine is an agricultural harvester and the process algorithm is determined depending on the harvesting conditions of the agricultural harvester. Since the machinist during the harvesting process must perform a plurality of control and monitoring functions directly related to the harvesting steps, with the use of the inventive method he is substantially relieved from optimization functions, so that he can concentrate on the harvesting process itself.

In order to improve the optimization results of the data processing system of which the inventive method is based, the process algorithms provided in the data processing system can be also adaptable to new or changing conditions by expert questioning.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a schematic side view of an agricultural harvester;

FIG. 2 is a view showing a structural diagram of a data processing device in accordance with the present invention;

FIG. 3 is a view showing a general structure of a method in accordance with the present invention in a signal flow chart illustration;

FIG. 4 is a view showing a further general structure of the inventive method in a signal flow chart illustration;

FIG. 5 is a view showing a concrete embodiment example of the general structure of the inventive method in a signal flow chart illustration.

### DESCRIPTION OF THE PREFERRED EMBODIMENTS

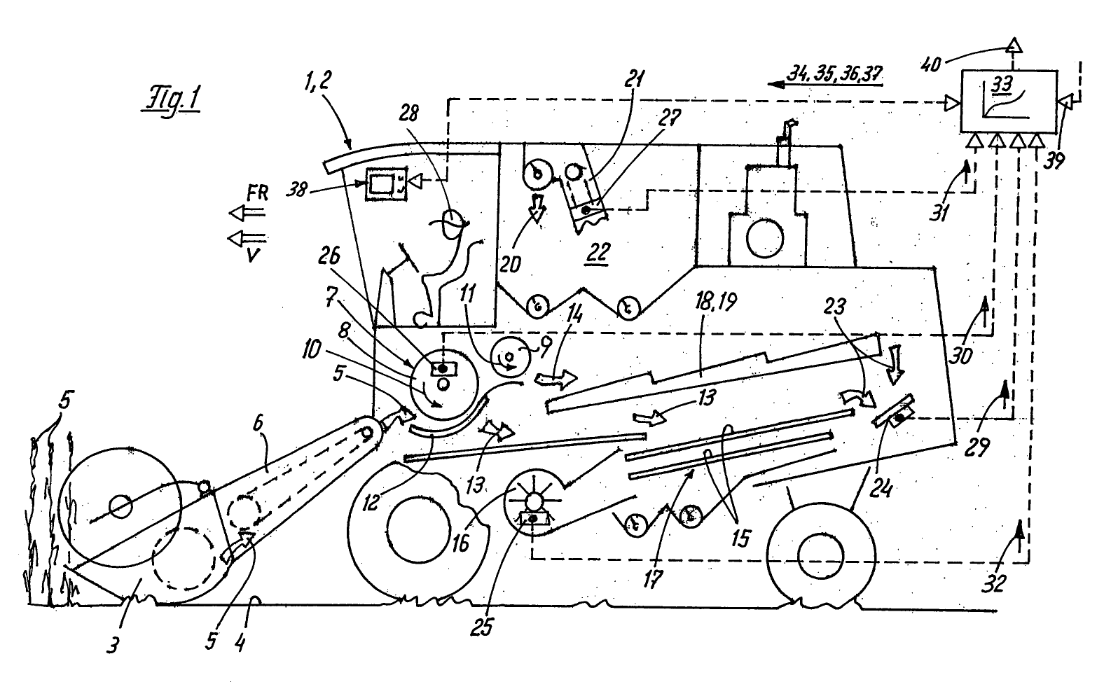

FIGS. 1-5 illustrate an inventive method for optimization of an adjustable parameters for an agricultural application. The invention however is not limited to this particular application, but instead can be used in different areas for obtaining the described effects.

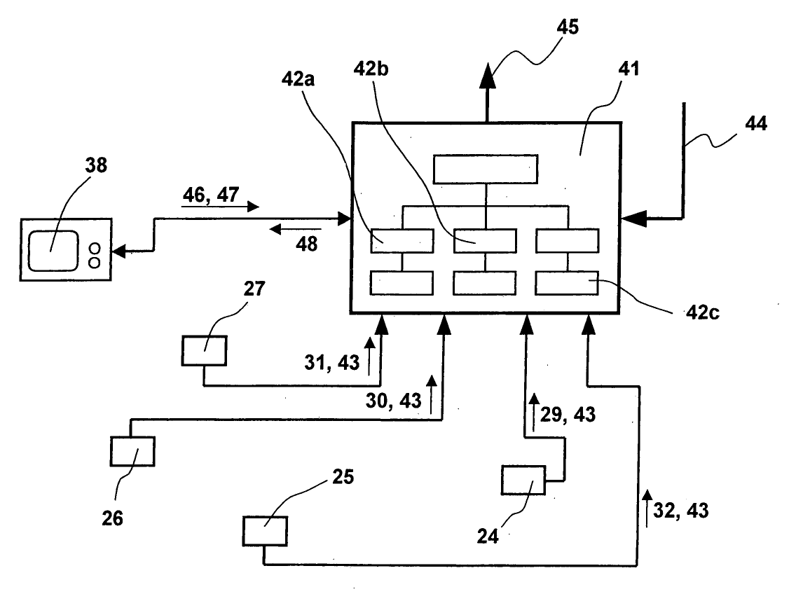

First of all, FIGS. 1 and 2 illustrate the inventive method for optimization of adjustable parameters in their general form, as it is applied to an agricultural harvester 1 formed as a combine harvester 2. The agricultural harvester 1 is provided with a grain cutting mechanism 3 which is located in a front-side region as considered in a traveling direction FR. The grain cutting mechanism 3 harvests a crop 5 which grows on a ground 4, brings it together and supplies in a rear region to an inclined conveyor 6 of the combine harvester 2. The inclined conveyor 6 transfers the crop 5 in its rear region to a threshing unit 7 which is composed in the shown embodiment of a threshing drum 8 and a following beater 9. It is within the framework of the invention that the threshing unit 7 in a known manner can be provided with several threshing drums 8 or can be formed as a so-called axial threshing and separating rotor. Under the action of the rotary movement 10, 11 of the threshing drum 11 and the subsequent beater 9, the crop 5 is transported along a threshing and cutting concave 12 to the rear region of the threshing unit 7.

The stream of the crop 5 is divided in different product streams 13 and 14. The product stream 13 which is separated by the threshing and cutting concave 12 is composed mainly of grain, and the product stream 14 which exits in the rearward region of the threshing unit 7 is composed mainly of straw. After the product streams 13 and 14 which exit the threshing unit 7, pass through further working, such as a cleaning device 17 which is composed one or several sieve planes 15 and an blower 16 which is associated with one of the sieve planes 15, and also a separating device 19 formed as a rack shaker 18, grains 20 from which admixtures are substantially removed are supplied then through a transporting unit 21 to a storage device 22 associated with the combine harvester 2. Depending on work quality of the working units 7, 17, 19 and the property of the crop 5, a greater or smaller grain stream 23 discharges in the rear region of the combine harvester 2. This grain stream 23 forms a so-called grain loss which can be determined by grain loss sensors 24 which are known and not illustrated in detail.

Operators 28 of such agricultural harvesters 1 attempt to keep this grain loss 23 as little as possible. For this purpose the combine harvester 2, in addition to the above described grain loss sensors 24, can be provided with further sensors 25, 26, 27 depending on the equipment degree, which in the simplest case can be formed as rotary speed sensors 25, 26, for determining the rotary speed of the blower 16 as well as the threshing drum 8. Furthermore, it is already known to use so-called throughput sensors 27 which for example determine the grain quantity 20 which passes through the combined harvester 2. Signals 29-32 which are generated by the different sensors 25-27 are converted in a computing unit 23 arranged on the combine harvester 2 for example into threshing drum rotary speed signals 34, grain loss signals 35, grain throughput signals 36 and signal blower rotary speed 37. These signals are indicated by an indicating unit 38 to the operator 28 permanently or upon inquiry.

Furthermore, it is also known that instead of determining the total grain corn loss 23 by the corn sensors 22, to determine separately the loss of individual working units such as of the cleaning device 17 or the separating device 19. In addition, it is also known in the prior art to determine the broken grain fraction of the harvested grain stream 20 and indicate it to the operator 28. The computing unit 33 can additionally receive informations 39 from external systems or transmit informations 40 to the external systems. With such systems the optimization of adjustable parameters is limited in that the operator 28 changes individual parameters of the working units 7, 17, 19 or the traveling speed and, based on the determined grain losses 35 or the grain breakage, estimates their influence on the working quality of the agricultural harvester 1. In the case of not satisfactory results, the individual parameter is changed until an acceptable working result of the combine harvester 2 is obtained. Such a process for optimization of adjustable parameters is very time- and labor-consuming. The inventive method of optimization of adjustable parameters is set for this case.

As shown in FIG. 2, the known sensors 24-27 are connected with a data processing system 41 which will be described herein below. Process algorithms 42a-c are provided in the data processing system 41 as also will be explained herein below. It is within the framework of the invention that the processing system 41 can be connected with any sensors arranged on the agricultural working machine 1. The data processing system 41 can be either installed directly on the agricultural harvester 1 and correspondingly carried by the operator 28 as a separate device, or can be arranged stationarily at a central location. In the latter both cases it is desirable to provide a wireless transmission of the corresponding sensor signals 29-32 to the data processing system 41 and from the data processing system 41 to the agricultural working machine 1. In addition to the sensor signals 29-32 which form the machine internal data 43, the inventive data processing system 41 can receive also so-called machine external data 44 from external systems or transmit data 45 to exterior systems. Furthermore, the data processing system 41 is connected for a data exchange with the indicating unit 38. This data exchange on the one hand includes the input of any data 46, in particular target data 47, to be written by the operator 28, and on the other hand the indication of output data 48 generated by the data processing system 41.

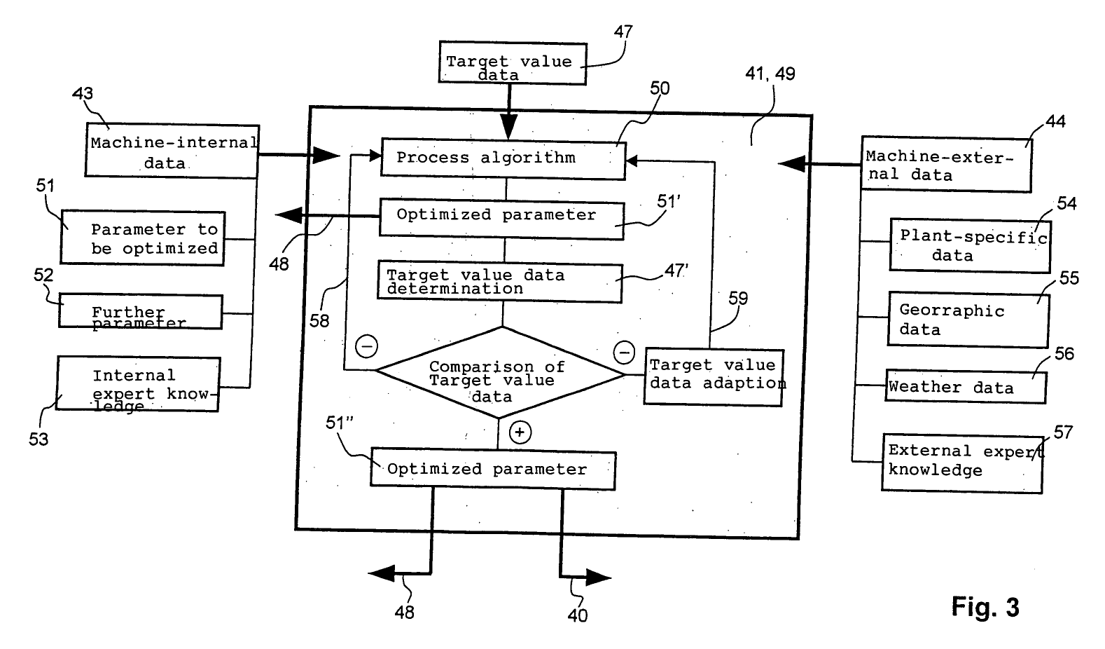

The inventive data processing system 41 is formed as a diagnosis system 49 as shown in FIG. 3. In the diagnosis system 49 at least one process algorithm 50 for optimization of adjustable parameters is provided. The information basis of the diagnosis system 49 is formed by machine-internal and machine-external data 43, 44 inputtable into the diagnosis system 49. Most important machine-internal data 43 can include a parameter 51 to be optimized, a traveling speed v of the agricultural harvester 1 in a simplest case, a rotary speed of one or several threshing drums 8, and also a rotary speed of the blower 16 of the cleaning device 17. It is within the framework of the invention that any adjustable parameters 51 of machine can be considered as long as their change, matching an optimization can lead to an improvement of the working operation as well as the working quality of the corresponding machine. The machine-internal data 43 include in addition so-called further parameters 52 which in the shown embodiment deal with crop-specific and machine-specific data. The crop-specific machine interior data 43 including in particular the grain loss 23 and the grain throughput 20.

Furthermore, in addition the crop moisture, the crop total throughput as well as the breakage fraction can be taken into consideration, wherein their determination can be performed in a known and therefore not described manner by sensors or by inputting in the data processing system 41. Machine-specific internal data 43 deal in the first place with the parameter adjustment region for the individual working unit 7, 17, 19 of the concrete machine and are based as a rule on general machine type-related manufacturer informations. In addition, the machine internal data 43 can include so-called internal expert knowledge 53, wherein the internal expert knowledge in the simplest case is generated by the operator 28 of the machine 1 and deals substantially with his knowledge and experience. In the agricultural application described here this internal knowledge 53 includes in particular the knowledge about the interaction between the crop properties and the adjustable parameters of the working elements as well as their action on the efficiency and the working quality of the agricultural harvester 1.

The machine external data 44 which are transmittable to the diagnosis system 39 include substantially plant-specific data 54, geographic data 55 and weather data 56 from the corresponding application region of the agricultural harvester 1 as well as so-called external expert knowledge 57. Such informations are retrievable for example through global data exchange and information system, such as the internet. In particular, for the above described agricultural application case they include accurate knowledge about the properties of the crop, the geographic specifics of the territory to be harvested, the weather conditions in this territory, as well as expert knowledge of specific meaning. This is related especially to the fact that the possible harvesting type periods are very short and the efficiency of the agricultural harvester 1 in the harvesting process substantially depends on the optimal determination of the adjustable parameters 51 on the crop properties with consideration of the outer influences.

For optimizing the adjustable parameter 51 of the agricultural working machine 1 with the use of the process algorithm 50 in the diagnosis system 49 in the inventive method, the above described target data 47 are inputtable into the diagnosis system 49. In the above described agricultural application case the target data 47 are for example limiting values for the grain loss 23 as well as the grain breakage.

Both the machine-internal and the machine-external data 43, 44 as well as the target data 47 form totally or partially the input data for the process algorithm 50 provided in the diagnosis system 49. The process algorithm 50 from these input data determines, as will be explained herein below, optimized adjustable parameter 51′, which either as so-called output data 48 directly automatically adjusts the corresponding working units 7, 17, 19 or provides indication for the operator 28 by the indicating device 38. In the last case, the operator 28 must carry out the adjustment of the optimized parameter 51′ himself. After the adjustment of the optimized parameter 51′, the reached target data 47′, such as substantially the grain loss 23, are determined in the above described manner.

In a further step the determined target data 47′ are compared with the preliminarily defined target data 47. If the determined target data 47 do not correspond to the preliminarily defined target data 47, the process algorithm 50 repeats a loop 58 until the preliminarily defined target data 47 are reached, or in accordance with a further loop 59 executes again an adaptation of the preliminarily defined target value 47 with the process algorithm 50. This adaptation of the target value 47 is particularly advantageous when the properties of the crop 5 or the outer conditions do not allow the preliminarily defined target values 47 completely or allow them only with not meaningful parameters 51′ of the working unit 7, 17, 19.

When the process algorithm 50 is successfully carried out, or in other words the determined optimized parameter 51 leads to target data 47′ which correspond to the preliminarily defined target data 47, the diagnosis system generates optimized adjustable parameter 51″. It is brought as described herein above, as output data 48 to the operator 28 for indication, or adjusted directly on the corresponding working units 7, 17, 19, automatically by the agricultural working machine 1. In addition, this optimized parameter 51″ and the machine-interior and the machine-exterior data 43, 44 on which it is based are made available as informations 40.

For ensuring a higher flexibility of the inventive data processing system 41, the data inputted in the data processing system 41 including the machine-internal data 43, the machine-external data 44 and the target data 47 as well as well as the output data 40, 48 generated by the data processing system 41 are editable and storable. This in addition has the advantage that the inputting data 43, 44, 47 as well as the data 40 regenerated by the data processing system 41 are reproducible and can be retrieved arbitrarily often.

Since in particular during harvesting of agricultural products the harvesting conditions which substantially determine the efficiency of the harvester 1 significantly change depending on the time of the day, in accordance with a further embodiment of the present invention, it is provided that the inventive process algorithm 50 operates in accordance with time control. This first of all has the advantage that the optimization of the adjustable parameter 51 can be repeated many times depending on the time of the day. It is within the framework of the invention that the time control can run automatically without releasingly by the machinist 28 of the new optimization process.

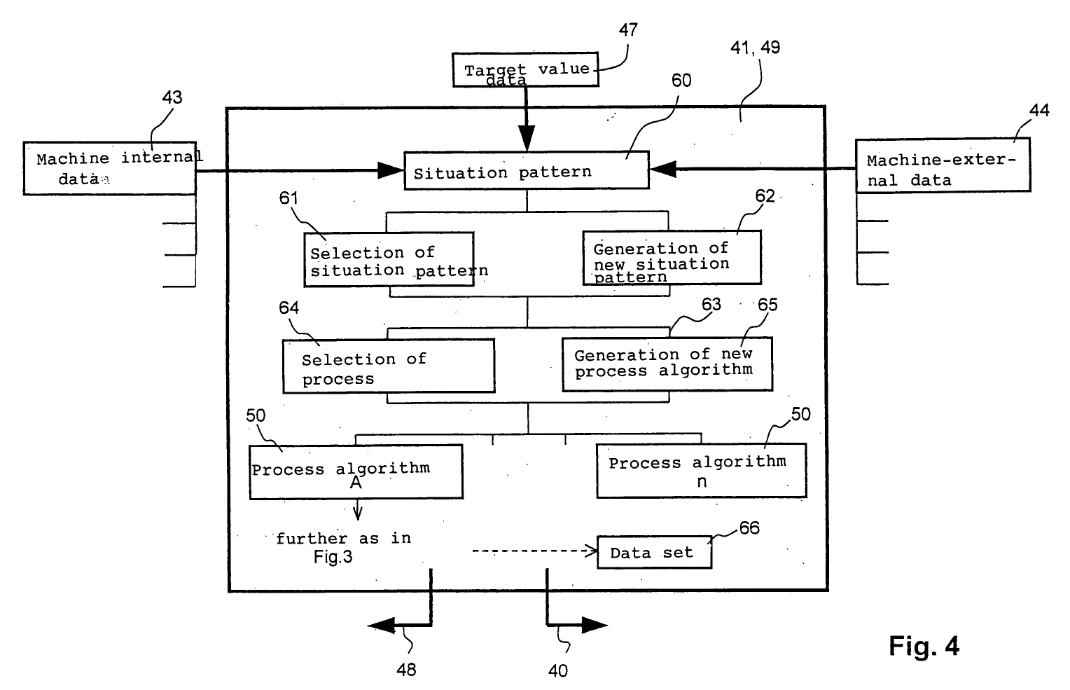

As shown in FIG. 4, in the inventive diagnosis system 49, a plurality of process algorithms 50 can be provided. This has in particular the advantage that for optimization of the adjustable parameter 51 a process algorithm 50 can be selected from a plurality of process algorithms 50, which depending on the underlying internal and external data 43, 44 as well as the time data 47 lead after short optimization time to optimized adjustable parameters 51. In particular, in dependence of the crop type, the crop moisture, the slope tendency and the available harvesting time, the parameter 51 which determines the optimization can have a priority, or mainly only meaningful completely determined parameter 51 is varied in fully determined regions to reach the predetermined or adapted target data 47 in the shortest possible time. In the case for example of favorable harvesting conditions (low crop moisture, flat terrain), the grain loss 23 provided as the target data 47 can be obtained fast and accurately, in that the selected process algorithm 50 is provided as the process diagnosis. Since no special peripheral conditions are to be considered, the parameters 51 to be optimized adjust the working inlets 7, 17, 19 in a sequence defined in the process algorithm 50.

Furthermore, the underlying process algorithm 50 can be formed as a case diagnosis. This has a special disadvantage that depending on the peripheral conditions predetermined by the machine-internal data 43, the machine-external data 44 and the target data 47, completely determined use cases are preliminarily defined, for which the special process algorithm 50 can be provided in the diagnosis system 49 and then can be retrieved being adapted to the special application case. As will be described herein below, this has in particular the advantage that the diagnosis system 49 reaches a so-called self-learning effect and the underlying process algorithms 50 are also adaptable precisely to completely determined application cases, so that a time period required for the optimization of the adjustable parameter 51 is always small. An efficiency of this self-learning effect can be especially valuable when the process algorithm 50 processes so-called model-oriented diagnoses which are universally usable and are simple to operate by the operator 28 of the agricultural machine 1 and adaptable to concrete machine models. The learning effect extends not only to a concrete application case, but also extends to a plurality of similar application cases which can be processed with the process algorithm 50 based on the model-oriented diagnosis.

The inventive data processing system 41 is conceptually designed so that depending on the machine-internal data 43 and/or the machine-external data 44 and/or the target data 47 from the plurality of process algorithms 50 integrated in it, the process algorithm 50 which is suitable for the special application case is proposed and automatically selected. As shown in FIG. 4, it is carried out in such a way that an application-specific situation patterns are provided in the inventive data processing system 41 as will be described herein below. They are defined by a selection of machine-internal data 43, machine-external data 44 and target data 47. During a concrete machine use, the machine-internal data 43, machine-external data 44 and target data 47 related to the concrete machine use are inputted in the inventive data processing system 41 as described herein above. In the data processing system 41 they are assembled to a concrete situation patterns 60. This concrete situation pattern 60 is then compared with the situation pattern 60 provided in the data processing system 41, and a situation pattern 60 which is the closest to the concrete situation pattern 60 or an identical pattern 61 is selected.

The data processing system 41 in addition is programmed so that with significant deviations between the concrete situation patterns 60 and the preliminarily defined situation patterns 60, new situation patterns 62 are generated and can be incorporated in the data processing system 41. The situation pattern 60-62 integrated in the data processing system 41 are linked through a comparing program step 63 with the process algorithm 50 provided in the data processing system 641, so that either directly the selection 64 of an already provided process algorithm 50 is a performed or by a further program step 65 a new process algorithm 50 is generated. If the data processing system 41 after running the program step 63 determines a suitable process algorithm 60, the further processing is performed in accordance with the description related to FIG. 3. For forming the situation patterns 60-62 as well as the process of the algorithm 50 reproducible, the data processing system 41 is designed so that the situation pattern 60-62 and the process algorithms 50 are provided in data sets 66 which include at least one selection of the machine-interior data 43, the machine-exterior data 44, and the target data 47, so that in subsequent application conditions which correspond to these data sets 66 directly the respective situation patterns 60-62 and process algorithms 50 can be obtained. In addition, the data processing system 41 is structured so that the data sets 66 thirdly as informations 40 are available. This in particular has the advantage that under same or similar conditions the used harvesters 1 can obtain the optimized adjusting parameters 51 with low expenses and fast.

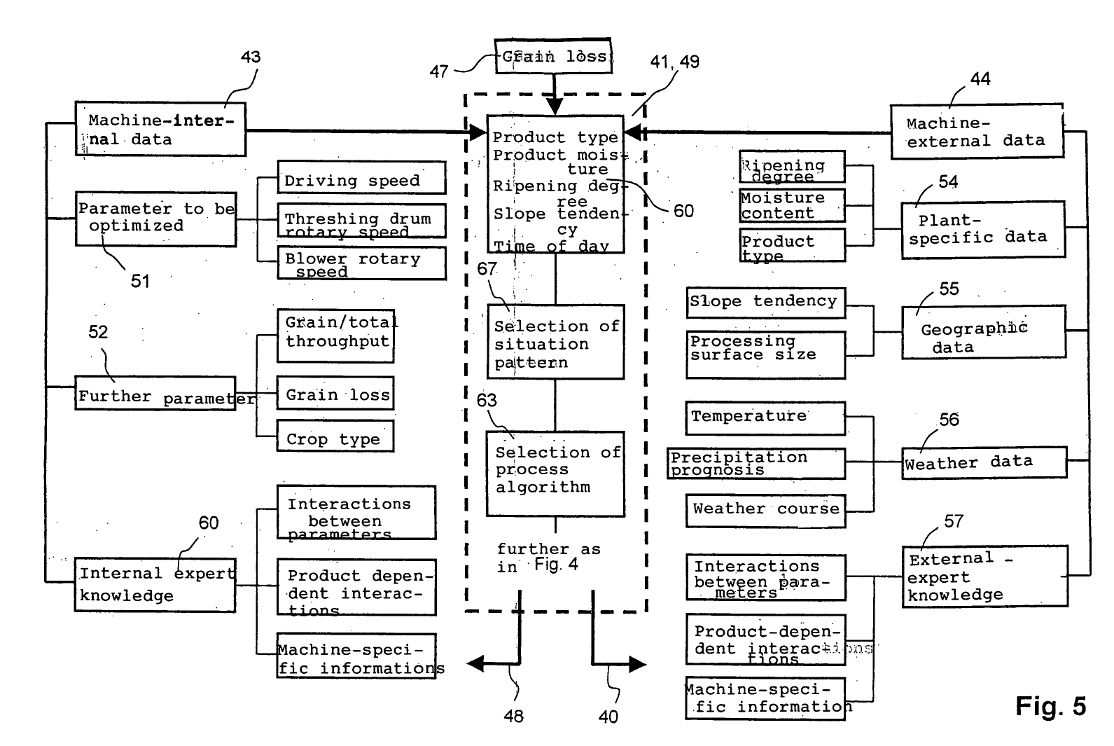

While the inventive methods in FIGS. 3 and 4 are described in a general form, FIG. 5 schematically shows a concrete application case for the inventive method without limiting the present invention to it. In the shown example the target data 47 which forms the optimization criterium are the corn losses of an agricultural harvester 1 formed as a combine harvester 2. The parameters 51 to be optimized include here the traveling speed of the harvester 1, the rotary speed of the threshing drum 8 and the rotary speed of the blower 18 of the cleaning device 17. The further parameters 52 are the machine-interior data 43 which here include the grain- and/or total throughput, the grain loss as well as the crop type. The internal expert knowledges 53 include here the interactions known to the operator 28 between the parameters 51 to be optimized which depend on the different machine-interior and machine-exterior data 43, 44, as well as the further parameters 52. Here in particular product type-dependent interaction play a particular role, as well as the machine-specific informations. The plant-specific data 54 as a region of the machine-external data 44, include for example the crop type, the ripening degree as well as the moisture content of the crop. With respect to the geographic data the processing surface size and the unevenness of the processing surface are especially important. In order to make conclusions about the possible use time, the further data 56 include air temperature statements, fall out prognoses as well as weather prognoses. The external expert knowledge 57 is structured in the shown embodiment example analogously to the internal expert knowledge 53.

In the inventive data processing system 41 an instantaneous situation pattern 60 is generated from the plurality of the machine-internal data 43, the machine-external data 44, and the target data 47. It is assembled in this case from informations about the product type, the product moisture, the ripening degree, the grain fraction, the slope tendency and the time of the day. The data can be based either qualitatively (low, average, high) or quantitatively as concrete numeral values. It is within the framework of the present invention that the situation pattern 60 can be composed of arbitrary other parameters which are meaningful for other application cases.

In a first program step 67 the data processing system 41 compares the concrete situation pattern 60 with the stored situation patterns 60 and selects for the further program course a situation pattern 60 which is close to the concrete situation pattern 60 or the same situation pattern 60. In a further program step 63, as was described with reference to FIG. 4, the process algorithm 50 linked with the selected situation pattern 60 is activated and processed. The processing of the selected algorithm 50 can be derived from FIG. 3. Depending on the machine-interior or machine-exterior data 43, 44, as well as the target data 47, the process algorithm defines the optimized parameter 51′, which then is either automatically adjusted on the working units 7, 17, 19 or is indicated for the operator 28 of the harvester 1 for adjustment. With these optimized parameter 51′, the harvester 1 is then operated and determines with the grain loss sensors 24 the instantaneous grain losses 23 of the harvester 1. The instantaneous grain losses 23 are transmitted as a part of the machine-internal data 43 to the data processing system 41 and compared in it with the predetermined target data 47. If these determined target data 47′ coincide with the predetermined target data 47, the running of the selected process algorithm 50 ends. If the determined target data 47′ do not coincide with the predefined target data 47, the process algorithm 50 runs in accordance with FIG. 3 until the optimized parameter 51″ is reached. It is also possible that the data processing system 41 carries out a target data adaptation 59.

An optimization of the adjustable parameters of an agricultural harvester 1 which is carried out in accordance with this method takes into consideration a plurality of peripheral conditions, which were not controllable by machinists who carry out the optimization. Despite the great number of parameters, with the inventive method a fast and precise optimization of the adjustable parameters 51 is possible. In addition, by the incorporation of the different data sets 66 in the data processing system 41, a fast reproducibility is provided, which also allows an arbitrary adaptation of the data sets 61. This has in particular a significant importance, since the considered expert knowledge is continuously perfected and therefore can be held permanently and uncomplicatedly at actual knowledge level.

It will be understood that each of the elements described above, or two or more together, may also find a useful application in other types of methods differing from the types described above.

While the invention has been illustrated and described as embodied in method of optimizing of adjustable parameters, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims.

1. A method of optimization of adjustable parameters of at least one machine, comprising the steps of providing a data processing system; and optimizing adjustable parameters by processing of at least one process algorithm provided in the data processing system.

2. A method as defined in claim 1; and further comprising determining the optimization of the adjustable parameter by target data selected from the group consisting of editable target data, storable target data, and both.

3. A method as defined in claim 1; and further comprising forming the data processing system as a diagnosis system.

4. A method as defined in claim 1; and further comprising processing by the data processing system machine-internal data and machine-external data with consideration of target data, and generating further-processible output data.

5. A method as defined in claim 4; and further comprising editing and storing the machine-internal data, the machine-external data and the output data by the data processing system.

6. A method as defined in claim 1; and further comprising operating the data processing system in a time controlled manner.

7. A method as defined in claim 4; and further comprising using as the machine-internal data the adjustable parameter to be optimized, a further parameter and an internal expert knowledge.

8. A method as defined in claim 7; and further comprising using as the adjustable parameter to be optimized a traveling speed, a rotary speed of at least one threshing drum and/or the rotary speed of a blower of at least one cleaning device.

9. A method as defined in claim 7; and further comprising using as the further parameter a crop-specific and/or machine-specific parameter; and performing the determination of the further parameter by sensors which are in operative communication with the machine or by inputting.

10. A method as defined in claim 9; and further comprising using as the further parameter a parameter selected from the group consisting of a grain loss, a grain throughput, a crop moisture, a crop total throughput and a broken corn portion.

11. A method as defined in claim 9; and further comprising using as the further parameter adjustment regions for parameters of working units of the machine.

12. A method as defined in claim 5; and further comprising generating the machine-external data by external systems and using as the machine-external data plant-specific data, geographic data, weather data and/or external expert knowledge.

13. A method as defined in claim 12; and further comprising using as the external expert knowledge and as internal expert knowledge crop and/or data and experience knowledge.

14. A method as defined in claim 1; and further comprising processing with the at least one process algorithm of the data processing device, of a diagnosis selected from the group consisting of process diagnosis, case diagnosis, model-oriented diagnosis, and combination thereof.

15. A method as defined in claim 1; and further comprising selecting the process algorithm to be processed from a plurality of process algorithms.

16. A method as defined in claim 1; and further comprising proposing or automatically selecting a process algorithm by the data processing system depending on data selected from the group consisting of machine-internal data, machine-external data, and target data.

17. A method as defined in claim 1; and further comprising defining situation patterns for the process algorithms by at least a part of data selected from the group consisting of machine-internal data, machine-external data, target data and combinations thereof; and selecting a situation pattern which comes close or is identical to an instantaneous situation pattern and a process algorithm linked to the situation pattern, depending on the at least one part of the machine-interior data and machine-exterior data with consideration of the target data which defines at least a part of an instantaneous situation pattern.

18. A method as defined in claim 1; and further comprising generation by the data processing system of changed process algorithms depending on machine-interior data and machine-exterior data and with consideration of changeable target data.

19. A method as defined in claim 1; and further comprising generating changed situation patterns by the data processing system in dependence on machine-interior data and machine-exterior data and with consideration of changeable target data.

20. A method as defined in claim 1; and further comprising storing process algorithms, situation patterns or both in data sets which include at least a part of machine-internal data, machine-external data and target data.

21. A method as defined in claim 1; and further comprising incorporating in the data processing system situation patterns and associated process algorithms and/or optimized adjustable parameters to be available for further machines.

22. A method as defined in claim 1, wherein the machine is an agricultural harvester; and further comprising determining at least one process algorithm depending on harvesting conditions of the agricultural harvester.

23. A method as defined in claim 1; and further comprising adapting the processing algorithm by expert questioning.
